(19) United States
(12) Patent Application Publication
(10) Pub. No.: US 2006/0278086 A1
(43) Pub. Date: Dec. 14, 2006

(54) Air cleaner, functional filter and method of manufacturing the filter, air cleaning filter, and air cleaner device

(75) Inventors: Jun Inagaki, Aichi (JP); Ryou Katou, Aichi (JP); Ryousuke Suga, Aichi (JP); Takahiro Nakajima, Aichi (JP); Yutaka Mori, Oosaka (JP); Naotsugu Souma, Aichi (JP); Kouhei Hashiguchi, Oosaka (JP); Kazuo Gensui, Aichi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Matsushita Electric Industrial Co., Ltd., Kadoma-shi (JP)

(21) Appl. No.: 10/560,367

(22) PCT Filed: Mar. 26, 2004
(86) PCT No.: PCT/JP04/04286

§ 371 Date: Aug. 18, 2006

(30) Foreign Application Priority Data
Jun. 12, 2003 (JP) 2003-167552
Jun. 20, 2003 (JP) 2003-176492
Jun. 20, 2003 (JP) 2003-176493

(51) Int. Cl. B01D 46/00

(52) U.S. Cl. 96/223

(57) ABSTRACT

An air cleaner of the present invention, wherein an inlet port 4 and an outlet port 5 are formed and provided with air blower means 1 therein, an antiallergenic filter having an aromatic hydroxyl compound is installed in the air flow passage of the air blower means 1 in a main body 2, and the inlet port 4 formed in the main body 2 is provided at the lower part of the front panel, such that the suction air flow may be formed along the floor plane 3, whereby pollen and dead mites, and the like, which are present in a vicinity of a floor plane 3 can be efficiently sucked to inactivate allergic activity. A treating solution of the present invention is characterized in that it is prepared by dissolving and/or dispersing a water-soluble material and a water-insoluble material in a mixed solvent of water and a cellosolve and/or a carbitol. A method of manufacturing functional filter according to the present invention is characterized in that the treating solution above is adhesion fixed to the filter base material. A functional filter according to the present invention is characterized in that it is manufactured by the above method of manufacturing. A device according to the present invention is characterized in that the functional filter of the present invention is disposed between the inlet port and the outlet port for air or water. An air cleaning filter of the present invention is characterized in that two or more materials selected from a material having antiallergenic properties, a material having antibacterial properties, a material having antivirus properties, and a material having antifungal properties, are adhesion fixed. A device of the present invention is characterized in that the filter of the present invention is disposed between the inlet port and the outlet port for air.

### TECHNICAL FIELD

The present invention relates to an air cleaner capable of reducing allergen ascribed to mites, pollen, and the like. The present invention furthermore relates to a collector filter for collecting suspended particulate matters in air or in water and method of manufacturing the filter, and to a functional filter which suppresses toxicity of the collected particulate matter substances and a simple method of manufacturing the same. Further, the present invention relates to a collector filter for collecting suspended particulate matters in air or in water and to a device for the same, and to an air cleaning filter which suppresses toxicity of the collected particulate matter substances and the application field of the same.

### BACKGROUND ART

As air cleaners of this type, conventionally known are those which suck in polluted air from the front panel and blow out the cleaned air from the top panel (for instance, reference can be made to JP-B-63-45607, pages 2-3, FIG. 4). The air cleaner is explained below by making reference to FIG. 6.

Referring to FIG. 6, the air cleaner is constructed by a main body casing 104 comprising an inlet port 101 on the front panel, an upward disposed outlet port 102 provided to the upper panel, and an air blower device 103 assembled inside, with a filter 105 provided to the inlet port 101.

Furthermore, allergen reducing agent capable of reducing allergens such as mites, pollen, and the like, is known in the art (for instance, reference can be made to JP-A-2003-81727, [0003], Table 1).

In the constitution of a conventional air cleaner above, the inlet port 101 is provided to cover approximately the entire front panel of the main body casing 104, and the air is blown upward from the outlet port 102 on the top panel. Accordingly, tobacco smoke and airborne dust can be sucked from the inlet port 101 disposed in the front panel of the main body casing 104 and they can be captured by the suction filter 105, however, there had been found problems that pollen, or dust mites such as deadmites, feces, and soon, which are incorporated in fluffy dust and the like that have once fallen on the floor inside a room could not be easily sucked in, and that the dust stirred up with the movement of human and the like had adverse effects on human body which could not be completely inactivated even in case they were collected on the filter 105.

In addition, these types of filters known in the art filter and capture the suspended toxic substances such as mites, pollen, bacteria, mold, viruses, and the like, on the filter. Because the filters above capture the allergenic proteins generated by mites, pollen, and the like, or the toxic substances such as bacteria, and viruses, and inactivate the captured toxic substances, their extension of application to air cleaners and ventilation systems is under way.

However, concerning the antiallergenic filters comprising antiallergenic agents added and fixed on the filter, as described in JP-A-2000-5531 and JP-A-2003-81727, those alone had the antiallergenic function only, and suffered problems that they needed additional processing for imparting them the antibacterial and antifungal functions, or for coloring.

Furthermore, the allergen inactivating method described in JP-A-2003-33612 comprises heating the captured allergenic substances with a stainless steel panel heating element, which realizes inactivation treatment by causing protein denaturation of the allergenic substances. However, this method had the problem that it required additional installation and equipment, i.e., heating means, and that it went against reducing energy consumption.

The antibacterial fiber disclosed in JP-A-2001-89974 comprises a substance, which suppresses the growth of bacteria, fixed on the surface of the fibers with a water-soluble polymer. This fiber requires utilizing a water-soluble polymer or a polymer which forms latex in an aqueous solution in order to be fixed, and was not applicable in case of a substance which causes sedimentation in water. Accordingly, there was a problem that there were limitations on the type of raw material usable in the fiber processing.

In the light of the aforementioned circumstances, an objective of the present invention is to provide, as a solution to the problems known in the art, an air cleaner which efficiently sucks in pollens, dead mites, and the like that are in the vicinity of the floor plane, and which exhibits antiallergenic effect for a long term.

Furthermore, the present invention relates to a collector filter for suspended particulate matters in air and water, and to a method of manufacturing the same; another objective of the present invention is to provide a functional filter which suppresses the toxicity of the collected particulate matter substances and a simple method for manufacturing the same.

Further, the present invention relates to a collector filter for suspended particulate matters in air and water, and to a device of the same; another objective of the present invention is to provide an air cleaning filter which suppresses the toxicity of the collected particulate matter substances and to provide an application field for the same.

### DISCLOSURE OF THE INVENTION

The present invention, which has been accomplished in order to solve the conventional problems as described above, comprises a main body formed thereon an inlet port and an outlet port and provided with air blower means therein, an antiallergenic filter having an aromatic hydroxyl compound installed in the air flow passage of an air blower means inside the main body, wherein the inlet port formed in the main body is provided at the lower part of the front panel, such that the suction air flow may be formed along the floor plane.

Further, the aromatic hydroxyl compound is constituted by poly-4-vinylphenol.

Furthermore, the outlet ports are provided to the both side panels of the main body.

Additionally, a dust sensor is provided to the lower part of the main body, and the air cleaner is so constituted that the main body is automatically operated when dust is detected by the dust sensor.

Moreover, an assistant inlet port is provided to the side panel of the main body.

Further, a shield part is provided so as to be protruded out from the side panel of the main body, on the front part of the assistant inlet port provided to the side panel of the main body, in such a manner that the assistant inlet port may not be directly visualized from the front side.

Furthermore, a deodorizing filter is provided inside the main body and a gas sensor is provided to the upper part of the main body, and the air cleaner is so constituted that the main body is automatically operated when a gas is detected by the gas sensor.

A treating solution according to the present invention, which solves the problems above, is characterized in that it is prepared by dissolving and/or dispersing a water-soluble material and a water-insoluble material in a mixed solvent of water and a cellosolve and/or a carbitol.

Furthermore, it is characterized in that the water-soluble material and the water-insoluble material are a mixture of two or more materials selected from a material having antibacterial properties, a material having antifungal properties, a material having antivirus properties, a material having antiallergenic properties, a material used as a colorant, and a material having hygroscopic properties.

Further, it is characterized in that the water-soluble material is a catechin.

Additionally, it is characterized in that the water-insoluble material is a high molecular antiallergenic agent having a high molecular phenolic hydroxyl group.

Further, it is characterized in that the ratio (volume ratio) of a cellosolve and/or a carbitol contained in the mixed solvent of water and a cellosolve and/or a carbitol is in a range from 20% to 99%.

Furthermore, a method for manufacturing a functional filter of the present invention is characterized in that the treating solution above is adhesion-fixed to a filter base material, and dried thereafter.

Further, a method for manufacturing a functional filter of the present invention is characterized in that the treating solution above is applied to the high-porosity part of the filter, and dried thereafter.

Further, a method for manufacturing a functional filter of the present invention is characterized in that a fiber raw material is immersed in the treating solution above, and the fiber obtained after drying is finished into a filter-like shape.

Moreover, it is characterized in that the drying temperature is 150° C. or lower.

Furthermore, a functional filter of the present invention is characterized in that it is manufactured by the method above.

Further, a humidifying filter of the present invention is characterized in that it is made by coating a filter formed from a water-absorbing filter base material with the treating solution above.

Furthermore, a device of the present invention is characterized in that a functional filter above and/or a humidifying filter above is/are disposed between an air inlet port and an outlet port.

Moreover, it is characterized in that a dust collector filter is provided to the back stage of the filter.

Furthermore, the device is characterized in that it is one selected from an air cleaner device, a ventilator device, a humidifier device, a heater device, a dehumidifier device, a mattress drier, and an air conditioner.

Further, a water treatment device of the present invention is characterized in that a functional filter above and/or a humidifying filter above is/are disposed between a water inlet port and a water discharge port.

Moreover, it is characterized in that the treating solution above is applied to the surface of the outer frame of the main body.

Furthermore, a mask of the present invention is characterized in that it comprises the functional filter above.

Further, a functional filter of the present invention is characterized in that it is colored using a treating solution which contains a material used as a colorant.

Further, a device of the present invention is characterized in that it is colored using a treating solution which contains a material used as a colorant.

An air cleaning filter according to the present invention, which solves the problems above, is characterized in that it contains adhesion fixed thereon two or more materials selected from a material having antiallergenic properties, a material having antibacterial properties, a material having antivirus properties, and a material having antifungal properties.

Furthermore, it is characterized in that the material having antiallergenic properties is an antiallergenic agent having a high molecular phenolic hydroxyl group.

Further, it is characterized in that a catechin is incorporated as a material having antivirus properties.

Further, it is characterized in that an enzyme is incorporated as a material having antibacterial properties.

Further, it is characterized in that it is colored using a material known as a colorant.

Moreover, it is characterized in that the material is adhered to the air cleaning filter at coverage of 0.1 to 10 g/m².

Furthermore, it is characterized in that the material is applied to the high-porosity part of the filter.

Further, a device of the present invention is characterized in that an air cleaning filter above is disposed between an air inlet port and an outlet port.

Moreover, it is characterized in that a dust collector filter is provided to the back stage of the air cleaning filter.

Furthermore, the device is characterized in that it is one selected from an air cleaner device, a ventilator device, a humidifier device, a heater device, a dehumidifier device, a mattress drier, and an air conditioner.

Further, a mask of the present invention is characterized in that it comprises an air cleaning filter above.

### BRIEF DESCRIPTION OF THE DRAWINGS

FIG. 1 is a vertical cross section view showing the constitution of an air cleaner according to the present invention;

FIG. 2 is an oblique view from the right hand side of the same air cleaner;

FIG. 3 is an oblique view from the left hand side of the same air cleaner;

FIG. 4 is a cross section view showing the constitution of air blower means of the same air cleaner;

FIG. 5 is a lateral cross section view showing the relation between the assistant inlet port and the shield part of the same air cleaner;

FIG. 6 is a cross section view of an air cleaner known in the art;

FIG. 7 is a graph showing the relation between the total adhered quantity of the treating solution and the dust collecting efficiency in Example 5;

FIG. 8 is a brief cross section view of an air cleaner according to Example 6;

FIG. 9 is a brief cross section view of a ventilator device according to Example 7;

FIG. 10 is a schematic view of a mask according to Example 8;

FIG. 11 is a brief cross section view of a humidifier device according to Example 9;

FIG. 12 is a brief cross section view of a heater device or a mattress drier according to Example 10; and

FIG. 13 is a brief cross section view of an air conditioner according to Example 11.

### BEST MODE FOR CARRYING OUT THE INVENTION

The invention described in claim 1 of the scope of claims comprises a main body with an inlet port and an outlet port formed thereon and provided with air blower means therein, an antiallergenic filter having an aromatic hydroxyl compound installed in the air flow passage of the air blower means inside the main body, wherein the inlet port formed in the main body is provided at the lower part of the front panel, such that the suction air flow may be formed along the floor plane; accordingly, it has such an effect that, pollen, dead mites, and the like, which are present on the floor plane or which are stirred up from the floor, are efficiently sucked from the inlet port, and the allergic activity thereof is inactivated by the antiallergenic filter.

The invention described in claim 2 of the scope of claims has such an effect that the filter exhibits stable antiallergic effect for a long term use even if moisture is adhered to the filter, because the aromatic hydroxyl compound is constituted by poly-4-vinylphenol.

The invention described in claim 3 of the scope of claims has such an effect that, by providing the outlet ports to the both side panels of the main body, the flow of air blown out from the side panels of the main body flow along the wall surface of a room to make a circulating flow, such that the dust and the like containing the allergenic substance suspended in the vicinity of the floor are guided to the inlet port.

The invention described in claim 4 of the scope of claims has such an effect, by a constitution as such that a dust sensor is provided to the lower part of the main body, and the main body is automatically operated when dust is detected by the dust sensor, that the dust sensor detects immediately such dust as are stirred up with the movement of human and the like, and the air cleaner can be operated timely.

The invention described in claim 5 of the scope of claims furthermore reduces allergenic substance in a room by an assistant inlet port provided to the side panel of the main body, such that the dust and the like that are stirred up inside the room can be taken in over a wide range not only from the front panel side but also from the sides of the side panel of the main body.

The invention described in claim 6 of the scope of claims comprises providing a shield part so as to be protruded out from the side panel of the main body, on the front part of the assistant inlet port provided to the side panel of the main body, in such a manner that the assistant inlet port may not be directly visualized from the front side; in this manner, the noise generating from the assistant inlet port can be cut off at the shield part, and at the same time, the design of the air cleaner can be improved by preventing direct visualization from the front of the assistant inlet port that is prone to be stained.

The invention described in claim 7 of the scope of claims employs a constitution as such that a deodorizing filter is provided inside the main body, that a gas sensor is provided to the upper part of the main body, and that the main body is automatically operated when a gas is detected by the gas sensor; accordingly, the gas components that tend to be diffused in the upper part are immediately detected by the gas sensor installed at the upper part of the main body, and the air cleaner can be operated timely to effectively remove tobacco smell, ammonia smell, and the like.

The method for manufacturing the functional filter according to the present invention is characterized in that a treating solution prepared by dissolving and/or dispersing a water-soluble material and a water-insoluble material in a mixed solvent of water and a cellosolve and/or a carbitol is applied to a filter, and dried thereafter. By using a mixed solvent of water and a cellosolve and/or a carbitol, a treating solution in which a water-soluble material and a water-insoluble material are dissolved and/or dispersed can be prepared without generating any precipitate that may form upon mixing a water-soluble material with a cellosolve and/or a carbitol, or a water-insoluble material with water. By applying the treating solution to the filter and drying thereafter, the water-soluble material and the water-insoluble material can be adhesion fixed to the filter by a single process step.

As the usable cellosolves, there can be mentioned ethylcellosolve, butylcellosolve, cellosolve acetate, and the like, but preferred are those having alkyl groups, and particularly preferred is butylcellosolve having a butyl group. Concerning carbitols, mentioned are methyl carbitol, ethyl carbitol, butyl carbitol, butyl carbitol acetate, carbitol acetate, carbitol acetate, and the like, but preferred are those having alkyl groups, and particularly preferred is butyl carbitol having a butyl group.

The mixing ratio of water with a cellosolve and/or a carbitol is not particularly limited, but the mixing ratio (volume ratio) of a cellosolve and/or a carbitol is preferably in a range from 20% to 99%, and more preferably, from 25% to 60%. With the condition that the total amount of water and a cellosolve and/or a carbitol is not exceeded, lower alcohols such as ethanol, isopropanol; polyhydric alcohols such as ethylene glycol, glycerol; or acetone and the like, maybe added to the solution singly or as a combination of plural types selected from them.

As the water-soluble materials and the water-insoluble materials that are dissolved and/or dispersed in the mixed solvent of water and a cellosolve and/or a carbitol, there may be mentioned a material having antibacterial properties, a material having antifungal properties, a material having antivirus properties, a material having antiallergenic properties, a material used as a colorant, a material having hygroscopic properties, and the like. The content of the water-soluble materials and the water-insoluble materials is preferably from 10% to 40%, and more preferably, from 10% to 20%.

As the above materials having antibacterial properties, there can be mentioned inorganic compounds that elute metallic ions such as of silver, copper, and zinc; fine metallic particles of silver, copper, and zinc; agents such as iodine compounds, phenols, quaternary ammonium salts, imidazole compounds, benzoic acids, hydrogen peroxide, cresol, chlorohexyzine, IRGASAN, aldehydes, and sorbic acid; enzyme formulations such as lysozyme, cellulase, and protease; and natural component extracts such as catechins, bamboo extracts, hinoki extracts, wasabi extracts, and mustard extracts.

As the above materials having antifungal properties, mentioned are organic nitrogen compounds, organic sulfur compounds, organic acid esters, organic iodine based imidazole compounds, benzazol compounds, and the like.

Concerning materials having antivirus properties above, there can be mentioned inorganic compounds that elute metallic ions such as of silver, copper, and zinc; fine metallic particles of silver, copper, and zinc; lower alcohols, catechins, hinokitiol, and the like.

As catechins, effective are epigallocatechin gallate, epicatechin gallate, epigallocatechin, epicatechin, (+)catechin, and the group compounds thereof; as well as free theaflavine, theaflavine monogallate A, theaflavine monogallate B, theaflavine digallate, and the like; which can be obtained by extracting from green tea, tea, persimmon, and the like.

As materials having antiallergenic properties above, there can be mentioned tannic acid, hydroxybenzoic acid compounds, aromatic hydroxyl compounds, or salts thereof, or polymers thereof; carbonates of alkali metals, alum, laurylbenzenesulfonic acid salts, laurylsulfates, polyoxyethylene lauryl ether sulfates, catechins, and the like. Furthermore, as protein based allergen substances, there are dead mites, feces of mites, or crushed products thereof; or pollen, bacteria, mold, animal excretions, and other protein dust and the like.

As the materials for colorants above, there can be used any type of known pigments and dyes so long as they do not cause unfavorable results such as the formation of precipitates, phase separation, and the like, in the mixed solvent of water and a cellosolve and/or a carbitol. As pigments, there can be mentioned organic pigments such as those based on azo, polyazo, anthraquinone, quinacrydone, isoindoline, isoindolinone, phthalocyanine, perylene, DPP, fluorescent pigments, and the like; or inorganic pigments such as carbon black, synthetic silica, chromium oxide, iron oxide, titanium oxide, burnt pigment, zinc sulfide, and the like. As dyes, there can be mentioned alcohol-soluble dyes, oil-soluble dyes, fluorescent dyes, light-harvesting dyes, and the like.

As the materials having hygroscopic properties above, there can be mentioned, in addition to hygroscopic polymers such as polyetherester polymers, polyetheresteramide polymers, polyvinylpyrrolidone polymers, and crosslinked polyethylene oxide; silane coupling agent crosslinked products, and various types of inorganic compounds such as silica gel, and zeolites. Furthermore, it is also effective to mix a cationic, an anionic, or a nonionic surfactant that have deliquescence properties.

Methods for applying the treating solution above to the filter base material include dipping, spraying, gravure printing, and the like, which maybe properly selected depending on the thickness and the surface wettability of the filter base material. As the filter base material, which is coated with the treating solution, usable are filter base materials obtained by cutting a non-woven cloth into a desired size, a filter base material shaped into a desired size by using an adhesive or heat fusion, a honeycomb-shaped resin filter base material, and the like. Fiber raw material may be immersed into the treating solution, and the fiber obtained after drying may be spun and woven to be finished into a filter shape.

Concerning the material for use in the functional filter base material according to the present invention, there can be mentioned organic fibers such as of polypropylene, polyethylene, polyester, and polyamide; inorganic fibers such as of glass, magnesium silicate, and alumina; natural fibers such as cotton; as well as paper, resin-impregnated papers, and the like, but there is no particular limitation on the material to be used, so long as the material does not react with the treating solution to cause dissolution, deformation, and the like. Furthermore, similarly usable are materials having entrained pores, through which flow of air is feasible, such as foamed resins, e.g., foamed urethane, and foamed styrene; or foamed metals, e.g., foamed aluminum, foamed titanium, and foamed iron.

Concerning the drying method for the functional filter of the present invention, there may be used natural drying, heating, or a method of evaporating the solvent under reduced pressure. However, drying at high temperatures may cause deformation ascribed to shrinking of the filter fibers, or deterioration of the material in the treating solution; accordingly, the temperature is preferably 150° C. or lower, and more preferably, drying is performed at a temperature of 100° C. or lower.

Since the functional filter according to the present invention comprises a filter having adhered thereon two or more materials selected from a material having antibacterial properties, a material having antifungal properties, a material having antivirus properties, a material having antiallergenic properties, a material used as a colorant, and a material having hygroscopic properties, it can filter and collect on the filter, the suspended toxic substances such as mite, pollen, bacteria, mold, virus, and the like, which are suspended in air or in water, and can inactivate the toxic substances collected thereon. The materials to be adhered on the filter may be properly selected depending on the substance that is collected for inactivation.

Furthermore, by simultaneously mixing a colorant into the treating solution, there can be obtained such an effect that the filter can be designed to have a visually favorable appearance having designing degree of freedom in color.

Moreover, by simultaneously mixing a material having hygroscopic properties, water contained in air can be condensed on the filter. Accordingly, effective components for antibacterial, antifungal, antiallergenic, and antivirus effects can be efficiently eluted and brought into contact with the toxic substances for inactivation.

In case the filter base material of the present invention is not uniform in density, and contains parts with higher and lower porosities, the treating solution is preferably applied to the part having higher porosity. Here, porosity refers to the weight value per unit volume, and a higher porosity signifies a larger spacing among the filter fibers. By treating parts of higher porosity, an increase in pressure loss can be suppressed when used as a filter, and the capturing efficiency of toxic substances can be increased at the same time.

As the functional filter according to the present invention, the adhesion fixed filter having imparted the effect above may be used alone, or a dust collector filter with finer opening may be provided to the back stage. In case a dust collector filter with finer opening is used in the back stage, each may be adhered in order to impart strength to the filter. In case the adhesion fixed filter and the dust collector filter are brought into contact with each other mechanically by the air flow, they may simply be superposed.

The functional filter thus manufactured is used by interposing it between the air inlet port and the outlet port of, for instance, an air cleaner device, a ventilator device, a humidifier device, and a heater device. By using those devices, indoor air can be cleaned, and can realize an effect of prevention against mycotic diseases, bacterial infection, and virus infection such as influenza.

Furthermore, by incorporating the functional filter manufactured in the above manner to a part of a mask or to the entire draft, suction of suspended toxic substances such as mite, pollen, bacteria, mold, and virus, into human body can be prevented from occurring; thus, there can be obtained an effect of preventing mycotic diseases, bacterial infection, and virus infection such as influenza.

The humidifying filter according to the present invention comprises a water-absorbing filter base material having adhered thereon two or more materials selected from a material having antibacterial properties, a material having antifungal properties, a material having antivirus properties, a material having anti allergenic properties, a material used as a colorant, and a material having hygroscopic properties. By immersing a part of the water-absorbing filter base material into water, or by supplying water from the upper part, the air passing through the filter is humidified, and, at the same time, the suspended toxic substances such as mite, pollen, bacteria, mold, virus, and the like, which are suspended in air or in water, are filtered and collected on the filter, and the toxic substance collected thereon can be inactivated. The materials to be adhered on the filter may be properly selected depending on the substance that is collected for inactivation. Furthermore, by simultaneously mixing a colorant, there can be obtained such an effect that the filter can be designed into a visually favorable appearance having designing degree of freedom in color.

The air cleaning filter according to the present invention comprises a filter having adhered thereon one or more materials selected from a material having antiallergenic properties, a material having antibacterial properties, a material having antivirus properties, and a material having antifungal properties; accordingly, suspended toxic substances such as mite, pollen, bacteria, mold, and virus, which are suspended in air, can be filtered and collected on the filter, and the toxic substance collected thereon can be inactivated. The materials to be adhered on the filter may be properly selected depending on the substance that is collected for inactivation.

As the materials above having antiallergenic properties, there can be mentioned tannic acid, hydroxybenzoic acid compounds, aromatic hydroxyl compounds, or salts thereof, or polymers thereof; carbonates of alkali metals, alum, laurylbenzenesulfonic acid salts, laurylsulfates, polyoxyethylene lauryl ether sulfates, catechins, and the like. Furthermore, as protein based allergen substances, there are dead mites, feces of mites, or crushed products thereof; or pollen, bacteria, mold, animal excretions, and other protein dust and the like.

Concerning the materials having antivirus properties above, there can be mentioned inorganic compounds that elute metallic ions such as of silver, copper, and zinc; fine metallic particles of silver, copper, and zinc; lower alcohols, catechins, hinokitiol, and the like.

As catechins, effective are epigallocatechin gallate, epicatechin gallate, epigallocatechin, epicatechin, (+)catechin, and the group compounds thereof; as well as free theaflavine, theaflavine monogallate A, theaflavine monogallate B, theaflavine digallate, and the like; which can be obtained by extracting from green tea, tea, persimmon, and the like.

As the above materials having antibacterial properties, there can be mentioned inorganic compounds that elute metallic ions such as of silver, copper, and zinc; fine metallic particles of silver, copper, and zinc; agents such as iodine compounds, phenols, quaternary ammonium salts, imidazole compounds, benzoic acids, hydrogen peroxide, cresol, chlorohexyzine, IRGASAN, aldehydes, and sorbic acid; enzyme formulations such as lysozyme, cellulase, and protease; and natural component extracts such as catechins, bamboo extracts, hinoki extracts, wasabi extracts, and mustard extracts.

As the above materials having antifungal properties, mentioned are organic nitrogen compounds, organic sulfur compounds, organic acid esters, organic iodine based imidazole compounds, benzazol compounds, and the like.

If the amount of the material to be adhered to the air cleaning filter is too small, the functions such as antiallergenic, antibacterial, antivirus, and antifungal, cannot be fully exhibited. If the amount is too large, the pressure loss of the filter increases: this lowers the air permeability to make the capture of toxic substance in air insufficient, and in a case it is mounted on a device, this provides causes of the problems of increasing power consumption and of generating noise. The amount of the adhered material on the filter is preferably in a range of from 0.1 to 10 g/m², and more preferably, from 1 to 5 g/m².

The material above is adhered to the filter by methods such as dipping, spraying, gravure printing, and the like, which may be properly selected depending on the thickness and the surface wettability of the filter. As the filter, which is coated with the treating solution in which the materials are dissolved and/or dispersed, usable are filters obtained by cutting a non-woven cloth into a desired size, a filter shaped into a desired size by using an adhesive or heat fusion, a honeycomb-shaped resin filter, and the like. Fiber raw material may be immersed into the treating solution, and the fiber obtained after drying may be spun and woven to finish into a filter shape.

Concerning the material for use as the filter base material to which the material is adhered, there can be mentioned organic fibers such as of polypropylene, polyethylene, polyester, and polyamide; inorganic fibers such as of glass, magnesium silicate, and alumina; natural fibers such as cotton; as well as paper, resin-impregnated papers, and the like, but there is no particular limitation on the material to be used, so long as the material does not react with the treating solution to cause dissolution, deformation, and the like. Furthermore, similarly usable are materials having entrained pores, through which flow of air is feasible, such as foamed resins, e.g., foamed urethane, and foamed styrene; or foamed metals, e.g., foamed aluminum, foamed titanium, and foamed iron.

Concerning the drying method for the air cleaning filter of the present invention, there may be used natural drying, heating, or a method of evaporating the solvent under reduced pressure. However, in a case that an organic material such as a fiber is used, drying at high temperatures may cause deformation ascribed to shrinking of the filter fibers, or deterioration of the material in the treating solution; accordingly, the temperature is preferably 150° C. or lower, and more preferably, drying is performed at a temperature of 100° C. or lower. In a case an inorganic or a metallic material is used, treatment can be made in a temperature range in which the shape of the material is still maintained.

In a case the filter base material of the present invention is not uniform in density, and contains parts with higher and lower porosities, the treating solution is preferably applied to the part having higher porosity. Here, porosity refers to the weight value per unit volume, and a higher porosity signifies a larger spacing among the filter fibers. By treating parts of higher porosity, an increase in pressure loss can be suppressed when used as a filter, and, the capturing efficiency of toxic substances can be increased at the same time.

Furthermore, by simultaneously mixing a colorant when the material is adhered to the filter, there can be obtained such an effect that the filter can be designed into a visually favorable appearance having designing degree of freedom in color.

As the materials for the colorants above, there can be used any type of known pigments and dyes. As pigments, there can be mentioned organic pigments such as those based on azo, polyazo, anthraquinone, quinacrydone, isoindoline, isoindolinone, phthalocyanine, perylene, DPP, and fluorescent pigments; or inorganic pigments such as carbon black, synthetic silica, chromium oxide, iron oxide, titanium oxide, burnt pigment, and zinc sulfide. As dyes, there can be mentioned alcohol-soluble dyes, oil-soluble dyes, fluorescent dyes, light-harvesting dyes, and the like.

In the air cleaning filter according to the present invention, the adhesion fixed filter having imparted the effect above may be used alone, or a dust collector filter with finer opening may be provided to the back stage. In case a dust collector filter with finer opening is used in the back stage, each may be adhered in order to impart strength to the filter. In a case the adhesion fixed filter and the dust collector filter are brought into contact with each other mechanically by the air flow, they may simply be superposed.

The treating solution having dissolved and/or dispersed therein the materials for use in manufacturing the air cleaning filter of the present invention may be of any type, but in a case both of the water-soluble material and the water-insoluble material are contained as the materials, it is preferred to use a treating solution prepared by dissolving and/or dispersing the materials in a mixed solvent of water and a cellosolve and/or a carbitol. By using a mixed solvent of water and a cellosolve and/or a carbitol, a treating solution having dissolved and/or dispersed therein a water-soluble material and a water-insoluble material can be prepared without generating any precipitate that may be formed upon mixing a water-soluble material with a cellosolve and/or a carbitol, or a water-insoluble material with water. As the usable cellosolves, there can be mentioned ethylcellosolve, butylcellosolve, cellosolve acetate, and the like, but preferred are those having alkyl groups, and particularly preferred is butylcellosolve having a butyl group. Concerning carbitols, mentioned are methyl carbitol, ethyl carbitol, butyl carbitol, butyl carbitol acetate, carbitol acetate, carbitol acetate, and the like, but preferred are those having alkyl groups, and particularly preferred is butyl carbitol having a butyl group.

The air cleaning filter manufactured in the manner above is used by interposing it between the air inlet port and the outlet port of, for instance, an air cleaner device, a ventilator device, a humidifier device, and a heater device. By using those devices, indoor air can be cleaned, and can realize an effect of prevention against mycotic diseases, bacterial infection, and virus infection such as influenza.

Furthermore, by incorporating the air cleaning filter manufactured in the above manner to a part of a mask or to the entire draft, suction of suspended toxic substances such as mite, pollen, bacteria, mold, and virus, into human body can be prevented from occurring; thus, there can be obtained an effect of preventing mycotic diseases, bacterial infection, and virus infection such as influenza.

### EXAMPLES

The present invention is explained in further detail below by means of examples, but it should be understood that the present invention is not limited to the description below.

### Example 1

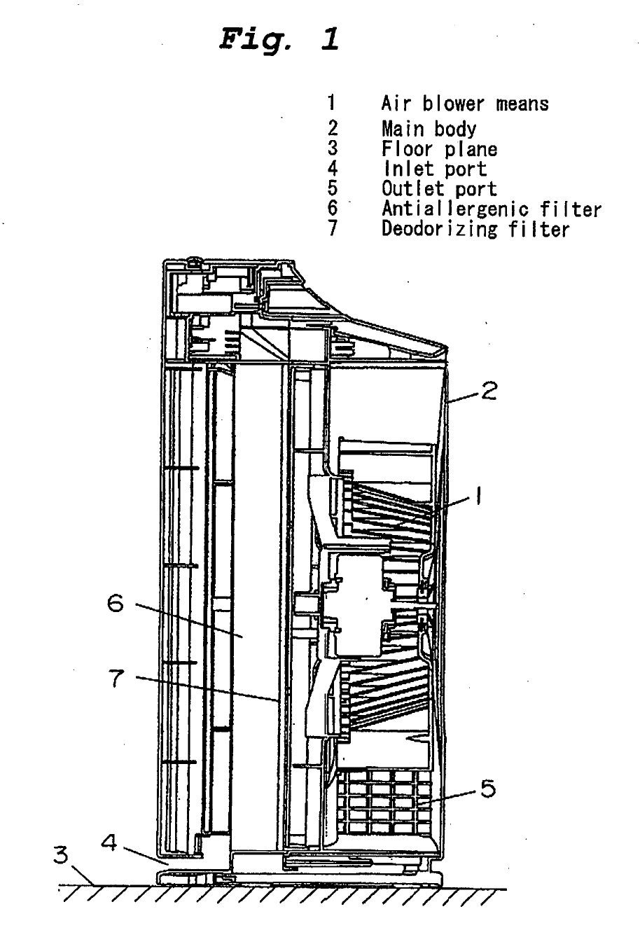

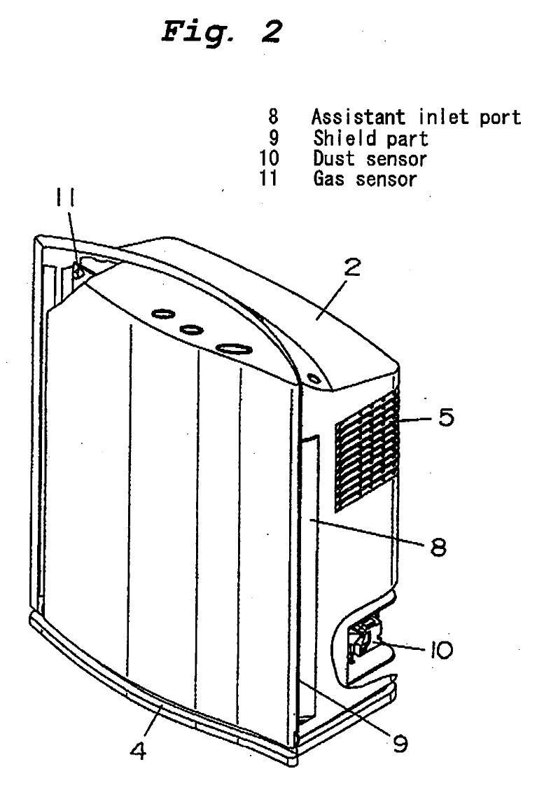

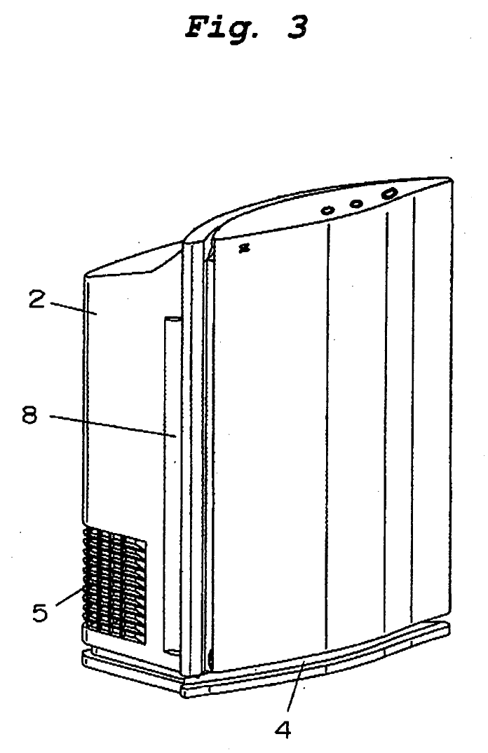

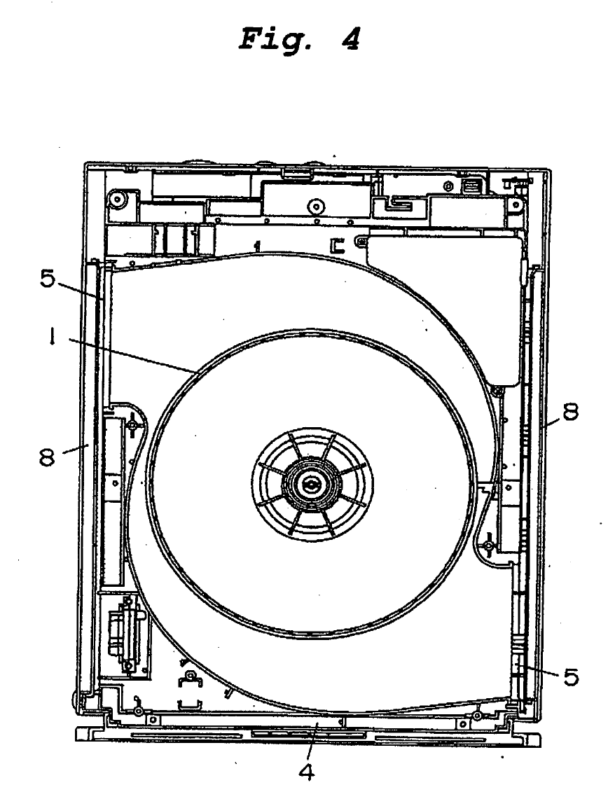

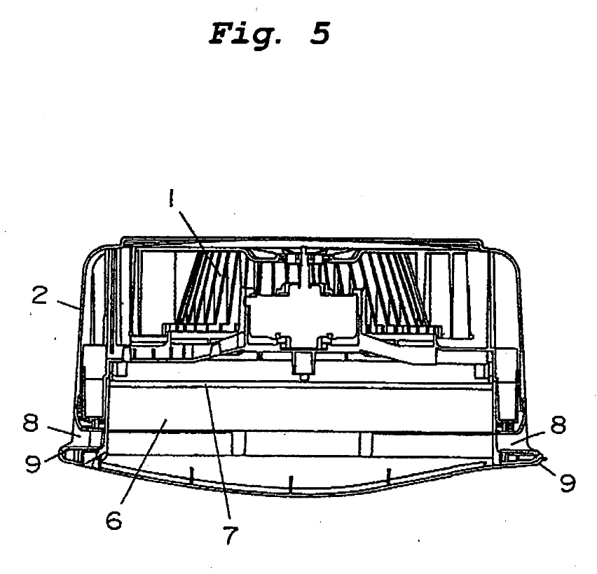

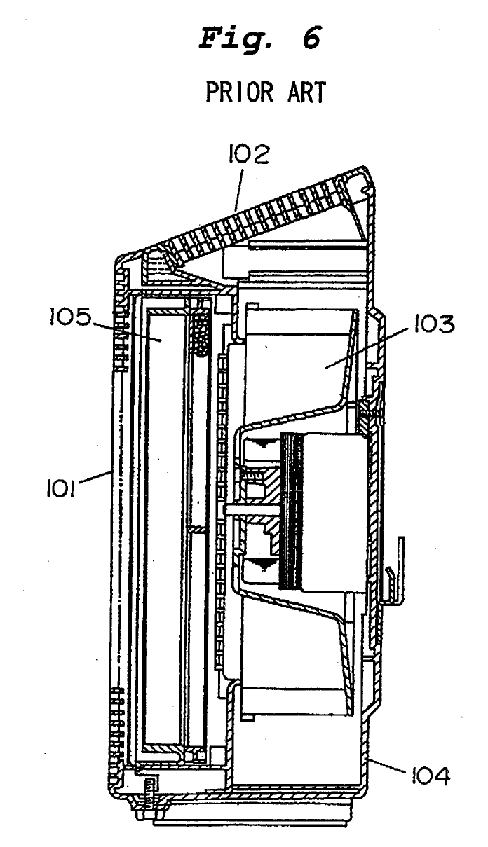

As shown in FIGS. 1 to 5, to a main body 2 having air blower means 1 installed therein, there are provided an inlet port 4 at the lower part of the front panel and outlet ports 5 at both side panels of the main body 2, such that an intake air flow is formed along the floor plane 3 on which the main body 2 is installed.

An antiallergenic filter 6 and a deodorizing filter 7 are disposed in the air flow path of the air blower means 1. The antiallergenic filter 6 is made by coating a glass-fiber high performance filter with an aromatic hydroxyl compound comprising poly-4-vinylphenol, but also usable for the filter are non-woven cloth, electret filter, honeycomb filter, HEPA filter, and the like, which may be properly selected depending on the needs.

Furthermore, an assistant inlet port 8 is provided to the side panel of the main body 2, and a shield part 9 is provided so as to be protruded out from the side panel of the main body 2, on the front part of the assistant inlet port 8, such that the assistant inlet port 8 may not be directly visualized from the front side. A dust sensor 10 is provided to the lower part of the main body 2, and is set as such that the air blower means 1 assembled in the main body 2 is automatically operated in a case detection is made by the dust sensor 10.

Further, it is constructed as such that a gas sensor 11 is provided to the upper part of the main body 2, and in case a gas is detected by the gas sensor 11, the air blower means 1 assembled inside the main body 2 is automatically operated for deodorization by using the deodorizing filter 7 provided inside the main body 2.

In the constitution above, in case the presence of pollen, dust, and the like in the vicinity of the floor plane 3 on which the main body 2 of the air cleaner is installed is detected by the dust sensor 10, the signal from the dust sensor 10 is received, and the air blower means 1 is automatically operated via the control part (not shown in the figure). In this instance, a suction air flow along the floor plane 3 is formed by the inlet port 4 provided to the lower part of the main body 2, such that the pollen, dust, and the like in the vicinity of the floor plane 3 are sucked into the inlet port 4, and pollen as well as dead mites and the like that are present inside the dust are captured by the antiallergenic filter 6 provided inside the main body 2, which are then inactivated in the antiallergenic filter 6.

Furthermore, when tobacco smoke, ammonia gas, and the like are detected by the gas sensor 11 provided at the upper part of the main body 2, the signal from the gas sensor 11 is received, and the air blower means 1 is automatically operated via the control part to remove the tobacco smell, ammonia smell, and the like with the deodorizing filter 7 installed inside the main body 2.

Thus, according to the air cleaner of Example 1 of the present invention, there is provided a main body 2 with an inlet port 4 and an outlet port 5 formed thereon and provided with air blower means 1 therein, an antiallergenic filter 7 having an aromatic hydroxyl compound installed in the air flow passage of the air blower means 1 inside the main body 2, wherein the inlet port 4 formed in the main body 2 is provided at the lower part of the front panel, such that the suction air flow may be formed along the floor plane 3 on which the main body 2 of the air cleaner is installed; in this manner, pollen as well as the dead mites and the mite feces that are included in the fluffy dust and the like, which fall on the floor plane 3 and which are stirred up from the floor thereafter, are efficiently sucked from the lower part of the main body 2, and the allergic activity thereof is inactivated by the antiallergenic filter 7, such that the inactivation of the allergic activity is maintained even after the dust is scattered again.

Furthermore, by constituting the aromatic hydroxyl compound with poly-4-vinylphenol, poly-4-vinylphenol remains undetached from the filter even in a case moisture is adhered to the filter, and a stable antiallergenic effect is realized over a long term.

Because the outlet ports 5 are provided to the both side panels of the main body 2, the two air flows discharged from the outlet ports 5 flow along the right and left wall surfaces, and are circulated into the inlet port 4; in this manner, the dust and the like which contain the allergenic substances and are suspended over the floor plane 3 are effectively guided to the inlet port 4.

Furthermore, by employing a constitution as such that a dust sensor 10 is provided to the lower part of the main body 2, and that the main body 2 is automatically operated in a case the dust sensor 10 detects dust, the main body 2 is automatically operated on detecting the dust stirred up from the floor plane 3 with the dust sensor 10; thus, timely removal of allergenic substance is made possible.

Further, because an assistant inlet port 8 is provided to the side panel of the main body 2, the dust suspended in the room can be sucked from a wide range over three directions on the floor plane, and the allergenic substance inside the room can be further reduced.

Moreover, because the shield part 9 is provided so as to be protruded out from the side panel of the main body 2, on the front part of the assistant inlet port 8 provided to the side panel of the main body 2 in such a manner that the assistant inlet port 8 may not be directly visualized from the front side, the noise generating from the assistant inlet port 8 can be cut off at the shield part 9, and at the same time, the design of the air cleaner can be improved by providing a clean appearance while preventing direct visualization of the stained assistant inlet port 8 from the front of the main body 2.

In addition, a deodorizing filter 7 is provided inside the main body 2 and a gas sensor 11 is provided to the upper part of the main body, and the main body 2 is automatically operated when a gas is detected by the gas sensor 11; accordingly, the gas detected by the gas sensor 11 is deodorized by the deodorizing filter 7 to timely and effectively remove the gas components such as tobacco smell, ammonia smell, and the like.

As is clearly understood from the example above, the present invention provides an air cleaner comprising a main body with an inlet port and an outlet port formed thereon and provided with air blower means therein, an antiallergenic filter having an aromatic hydroxyl compound installed in the air flow passage of the air blower means inside the main body, wherein the inlet port formed in the main body is provided at the lower part of the front panel, such that the suction air flow may be formed along the floor plane; accordingly, the dust and the like containing pollen and dead mites and that are in the vicinity of the floor plane are efficiently sucked, and the allergic activity thereof is inactivated.

Furthermore, because the aromatic hydroxyl compound is constituted by poly-4-vinylphenol, a long term stable antiallergenic effect is provided.

Further, because the outlet ports are provided to the both side panels of the main body, the dust and the like containing allergenic substance and that are stirred up in the vicinity of the floor plane can be guided to the inlet port side for efficient removal of allergenic substance.

Moreover, because a dust sensor is provided to the lower part of the main body, and because it is so constituted that the main body is automatically operated when dust is detected by the dust sensor, the air cleaner can be operated timely to remove the allergenic substance.

Further, because an assistant inlet port is provided to the side panel of the main body, dust can be sucked from a wide range to further reduce the allergenic substance in the room.

Furthermore, because a shield part is provided so as to be protruded out from the side panel of the main body, on the front part of the assistant inlet port provided to the side panel of the main body in such a manner that the assistant inlet port may not be directly visualized from the front side, the noise generating from the assistant inlet port can be reduced, and at the same time, the design of the air cleaner can be improved by providing a clean appearance while preventing direct visualization of the stained assistant inlet port.

In addition, because it is equipped with a deodorizing filter provided inside the main body and a gas sensor provided to the upper part of the main body, and because it is so constituted that the main body is automatically operated when a gas such as a bad smell content is detected by the gas sensor, the air cleaner can be operated timely to effectively remove tobacco smell, ammonia smell, and the like.

### Example 2

### Mixing of Water-soluble Material and Water-insoluble Material

As shown in Table 1, a water-soluble material and a water-insoluble material were mixed. The components were mixed at a ratio of 15% (volume ratio) with respect to the solvent, and after stirring for one minute using a mixer, the state of the solution after mixing was visually observed.

In a solvent containing single component, co-existence of a water-soluble material and a water-insoluble material led to the generation of precipitates, or two-phase separation, or a very small dissolution. A mixed solution with the generation of precipitates or the two-phase separation is practically unfeasible because it cannot be uniformly applied to the filter. In case only a small amount was dissolved, large productivity loss occurred because only small amount of components was applied to the filter by a single processing.

In the case of a mixed solvent containing butylcellosolve and water at a ratio of 1:1, a treating solution containing the components dissolved therein was prepared without suffering unfavorable phenomenon such as the formation of precipitates, two-phase separation, and the like, and was uniformly applicable to the filter. No precipitate generated in the treating solution with increasing ratio of butylcellosolve. On the contrary, an increase in water ratio exceeding 1:4 resulted in the formation of the precipitates of the components.

TABLE 1

| | Examples | | | | |
|---|---|---|---|---|---|
| | | | | | Butylcellosolve/ |
| Components | Water | Ethanol | Butylcellosolve | Hexane | water |
| Polyvinylphenol/ | Precipitation | Small | Dissolution | Separation | Dissolution |
| catechin | | dissolution | | into two | |
| | | | | phases | |
| Polyvinylphenol/ | Precipitation | Precipitation | Precipitation | No test data | Dissolution |
| lysozyme | | | | | |
| Polyvinylphenol/ | Precipitation | Small | Dissolution | Small | Dissolution |
| organic nitrogen | | dissolution | | dissolution | |
| based antifungal agent | | | | | |
| Catechin/ | Dissolution | Small | Small | Precipitation | Dissolution |
| lysozyme | | dissolution | dissolution | | |
| Catechin/ | Dissolution | Small | Small | Precipitation | Dissolution |
| organic nitrogen | | dissolution | dissolution | | |
| based antifungal agent | | | | | |
| Lysozyme/ | Precipitation | Precipitation | Precipitation | No test data | Dissolution |
| organic nitrogen | | | | | |
| based antifungal agent | | | | | |
| Polyvinylphenol/ | Precipitation | Dissolution | Dissolution | No test data | Dissolution |
| hygroscopic polymer/ | | | | | |
| colorant | | | | | |

### Comparative Example 1

TABLE 2

| | Comparative Examples | | | |
|---|---|---|---|---|
| Components | Water | Ethanol | Butylcellosolve | Hexane |
| Ag-apatite/alcohol | Precipitation | Stable | Stable | Stable |
| dispersion | | dispersion | dispersion | dispersion |
| Ag—TiO₂/water | Stable | Precipitation | Precipitation | Precipitation |
| Dispersion | dispersion | | | |
| Lysozyme | Dissolution | Precipitation | Precipitation | No test data |
| Protease | Dissolution | Precipitation | Precipitation | No test data |
| Catechin | Dissolution | Small dissolution | Small | Precipitation |
| | | | dissolution | |
| Polyvinylphenol | Precipitation | Dissolution | Dissolution | Dissolution |
| Organic nitrogen based | Dissolution | Dissolution | Dissolution | No test data |
| antifungal agent | | | | |

### Example 3

### Coating Filter with Treating Solution and Drying

Filters made from a polyester non-woven cloth were immersed in a treating solution containing catechin and polyvinyl phenol at a concentration of 15% (volume ratio) in a mixed solvent of water/cellosolves. After drawing out the filters from the treating solution, they were each dried at room temperature, 100° C., 150° C., and 200° C., respectively. About 4 hours was necessary to dry the filter at room temperature until no liquid adhered to the hand when the surface of the filter was touched. Similar dry state was achieved in 15 minutes by drying at 100° C. Although similar dry state was achieved in 10 minutes by drying at 150° C., discoloration was partly observed. On drying at 200° C., discoloration and shrinking deformation of the filter were observed in 10 minutes. Similar results were obtained on polypropylene honeycomb filters.

### Example 4

### Coating Filter with Treating Solution and Pressure Loss Measurement

A treating solution prepared by dissolving polyvinyl phenol, hygroscopic polymer, and catechin at a concentration of 15% (volume ratio) in a mixed solvent of water and cellosolves was sprayed onto polypropylene fibers, and the resulting product was dried at 100° C. for 15 minutes to obtain a functional filter. Air was flown at differing rate to the functional filter thus obtained to measure pressure loss and dust collecting efficiency. As read from Table 3, by adhering polyvinyl phenol, hygroscopic polymer, and catechin to the filter, small increase was observed in both pressure loss and dust collecting efficiency as compared with a non-treated filter.

TABLE 3

| | | Non-treated | Functional |
|---|---|---|---|
| | | filter | filter |
| Amount of adhered material | g/m² | 0 | 6.06 |
| Pressure loss(0.3 m/s) | Pa | 64.6 | 66.7 |
| Pressure loss(0.5 m/s) | Pa | 116.6 | 120.7 |
| Pressure loss(0.8 m/s) | Pa | 262.1 | 264.9 |
| ΔP (0.3 m/s) | Pa | — | 2.1 |
| ΔP (0.5 m/s) | Pa | — | 4.1 |
| ΔP (0.8 m/s) | Pa | — | 2.8 |
| Dust collecting efficiency | % | 99.8 | 99.9 |
| (0.3 m/s) | | | |
| Dust collecting efficiency | % | 97.7 | 98.7 |
| (0.5 m/s) | | | |
| Dust collecting efficiency | % | 97.3 | 97.4 |
| (0.8 m/s) | | | |

### Example 5

### Filter Part Coated with Treating Solution and Pressure Loss Measurement

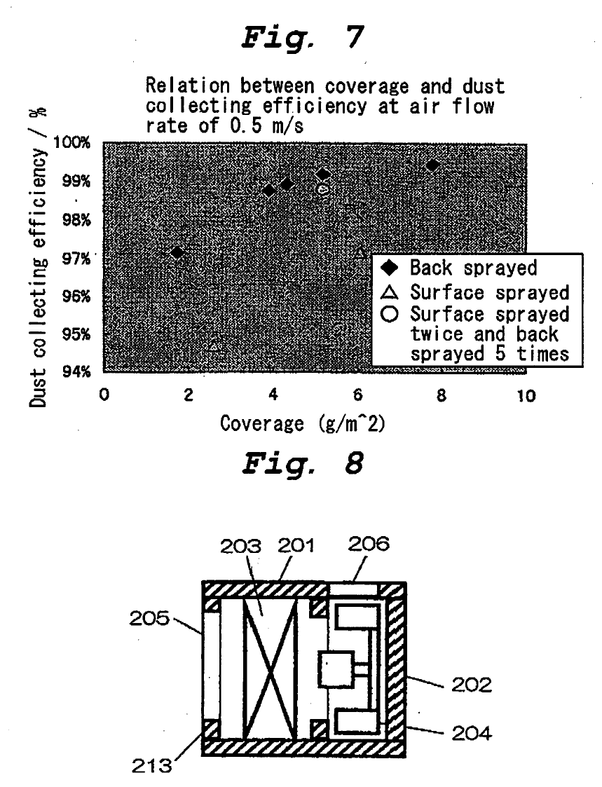

A dust collector filter having dense fiber morphology (low porosity), which is used for increasing dust collecting efficiency, was adhered to another dust collector filter consisting of less densely packed fibers but having excellent strength (high porosity) to obtain a filter (having low density on the backplane). Polyvinylphenol, hygroscopic polymer, and catechin were adhesion fixed on the resulting filter by a method similar to Example 4. Dust collecting efficiency was measured at an air flow rate of 0.5 m/s for the functional filters to which the materials were adhered in various amounts and in various directions. The results are given in FIG. 7. FIG. 7 clearly reads that dust collecting efficiency increases with increasing total adhesion fixed amount. In this case, the filter having the treating solution adhesion fixed on the surface having a higher porosity of the dust collector material exhibited superior dust collecting efficiency as compared with the filter having the treating solution adhesion fixed on the surface having lower porosity.

### Example 6

Referring to FIG. 8, the air cleaner device 201 is equipped with a functional filter 203 assembled inside a frame body 202, a fan 204, an inlet port 205, an outlet port 206, and an outer frame 213.

Polluted air containing mixed therein toxic pollution substances is sucked through the inlet port 205 of the air cleaner device 201 by the fan 204, and is sent to the functional filter 203, where a clean air is discharged and supplied from the outlet port 206, after filtering off the toxic pollution substances and cleaning the air with the filter.

In the above constitution, the functional filter 203 filters off, adsorbs and captures, and removes the suspended toxic substances such as mites, pollen, bacteria, mold, and viruses, and, at the same time, inactivates the suspended toxic substances such as mites, pollen, bacteria, mold, and viruses. By adhesion fixing inactivating agents corresponding to the suspended toxic substances to the filter, efficient adsorption removal and inactivation are achieved to provide an air cleaner capable of preventing re-scattering of substances still having toxicity.

Furthermore, a component which inactivates suspended toxic substances such as mites, pollen, bacteria, mold, and viruses, is applied to the outer frame 213 of the air cleaner device. When the air cleaner device is operated, suspended toxic substances tend to be adsorbed particularly in the vicinity of the inlet port 205. Accordingly, by any impact, they tend to be re-scattered and cause air pollution. In the constitution above, the outer frame 213 of the air cleaner device is coated with a component which inactivates the suspended toxic substances such as mites, pollen, bacteria, mold, and viruses; accordingly, suspended toxic substances are inactivated when they are adsorbed to the vicinity of the inlet port 205, and in this manner, re-scattering of toxic substances and air pollution can be prevented from occurring.

### Example 7

Referring to FIG. 9, a ventilator device 207 is equipped with a functional filter 212 assembled inside a duct 208, an air blower 209, an inlet port 210, an outlet port 211, and an outer frame 213.

Polluted air containing mixed therein toxic pollution substances is sucked through the inlet port 210 of the ventilator device 207 by the air blower 209, and is sent to the functional filter 212, where a clean air is discharged and supplied from the outlet port 211, after filtering off the toxic pollution substances and cleaning the air with the filter.

In the above constitution, the functional filter 212 filters off, adsorbs and captures, and removes the suspended toxic substances such as mites, pollen, bacteria, mold, and viruses, and, at the same time, inactivates the suspended toxic substances such as mites, pollen, bacteria, mold, and viruses. By adhesion fixing inactivating agents corresponding to the suspended toxic substances to the filter, efficient adsorption removal and inactivation are achieved to provide a ventilator device capable of preventing re-scattering of substances still having toxicity.

Furthermore, a component which inactivates suspended toxic substances such as mites, pollen, bacteria, mold, and viruses, is applied to the outer frame 213 of the ventilator device. When the ventilator device is operated, suspended toxic substances tend to be adsorbed particularly in the vicinity of the inlet port 210. Accordingly, by any impact, they tend to be re-scattered and cause air pollution. In the constitution above, the outer frame 213 of the ventilator device is coated with a component which inactivates the suspended toxic substances such as mites, pollen, bacteria, mold, and viruses; accordingly, suspended toxic substances are inactivated when they are adsorbed to the vicinity of the inlet port 210, and in this manner, re-scattering of toxic substances and air pollution can be prevented from occurring.

### Example 8

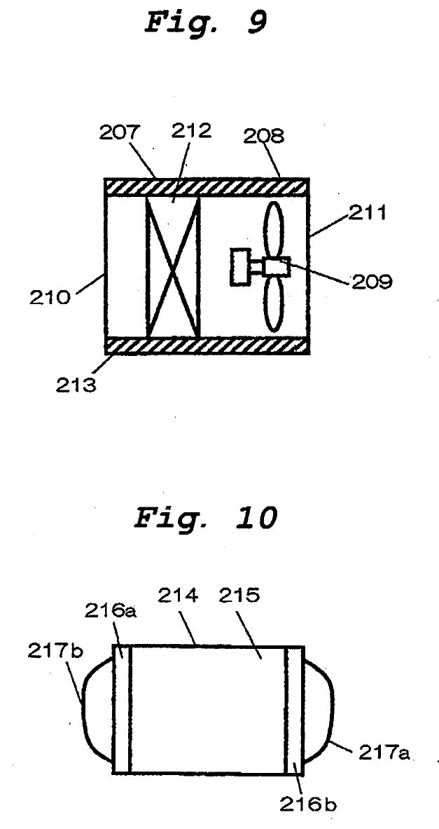

Referring to FIG. 10, a mask 214 comprises a functional filter 215, mask reinforcement part 216a, 216b, and band 217a, 217b.

Polluted air containing mixed therein toxic pollution substances is cleaned by filtering off the toxic pollution substances with the functional filter 215 of the mask 214.

In the constitution above, the suspended toxic substances such as mite, pollen, bacteria, mold, and virus, are filtered, adsorbed, captured, and removed by the functional filter 215, and the filter inactivates the suspended toxic substances such as mite, pollen, bacteria, mold, and virus. By adhering and fixing to the filter an inactivating agent properly selected for the suspended toxic substances, adsorption removal and inactivation can be efficiently performed to provide a mask capable of maintaining suction air clean for the users.

### Example 9

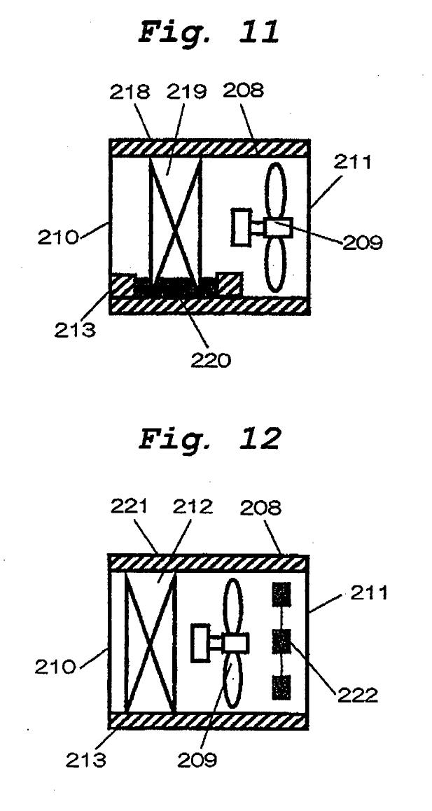

Referring to FIG. 11, a humidifier device 218 is equipped with a humidifying air cleaning filter 219 assembled inside a duct or a frame body 208, an air blower 209, an inlet port 210, an outlet port 211, a water supply portion 220 and an outer frame 213.

Polluted air containing mixed therein toxic pollution substances is humidified, and at the same time, the toxic pollution substances are filtered off and cleaned by the humidifying air cleaning filter 219 of the humidifier device 218.

In the constitution above, by either immersing into water a part of the filter constructed from a water-absorbing base material or supplying water from the upper part, the humidifying air cleaning filter 219 humidifies the air passing through the filter, and at the same time, the suspended toxic substances such as mite, pollen, bacteria, mold, and virus, which are filtered, adsorbed, captured, and removed, while the filter inactivates the suspended toxic substances such as mite, pollen, bacteria, mold, and virus. By adhering and fixing to the filter an inactivating agent properly selected for the suspended toxic substances, adsorption removal and inactivation can be efficiently performed to provide a humidifier device capable of humidifying, while preventing re-scattering of toxic substances from occurring.

### Example 10

Referring to FIG. 12, a heater device or a mattress drier 221 is equipped with an air blower 209 assembled inside a frame body 208, an inlet port 210, an outlet port 211, a functional filter 212, a heat source 222, and an outer frame 213.

Polluted air containing mixed therein toxic pollution substances is sucked through the inlet port 210 of the heater device or a mattress drier 221 by the air blower 209, and is sent to the functional filter 212, where, by filtering off the toxic pollution substances and cleaning the air with the filter, a clean air is produced, heated to make a warm air by the heat source 222, discharged and supplied from the outlet port 211. At this point, a bag may be provided to the outlet port 211 to pool warm air for drying mattress. The resulting device is mattress drier.

In the constitution above, the functional filter 212 filters, adsorbs, captures, and removes the suspended toxic substances such as mite, pollen, bacteria, mold, and virus, and then inactivates the suspended toxic substances such as mite, pollen, bacteria, mold, and virus. By adhesion fixing to the filter inactivating agents corresponding to the suspended toxic substances, efficient adsorption removal and inactivation are achieved to provide a heater device or a mattress drier capable of preventing re-scattering of substances still having toxicity.

### Example 11

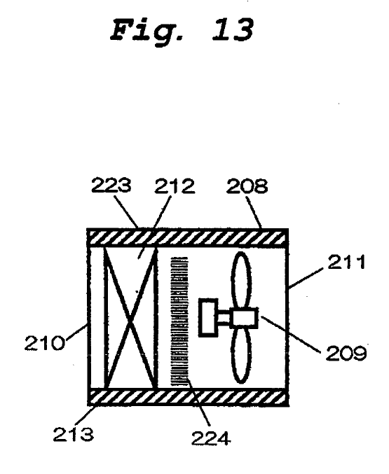

Referring to FIG. 13, an air conditioner 223 is equipped with an air blower 209 assembled inside a frame body 208, an inlet port 210, an outlet port 211, a functional filter 212, a heat exchanger 224, and an outer frame 213.

Polluted air containing mixed therein toxic pollution substances is sucked through the inlet port 210 of the air conditioner 223 by the air blower 209, and is sent to the functional filter 212, where, by filtering off the toxic pollution substances and cleaning the air with the filter, a clean air is produced, heat-exchanged in the heat exchanger 224 to make a warm air or a cold air, and discharged and supplied from the outlet port 211.

In the constitution above, the functional filter 212 filters, adsorbs, captures, and removes the suspended toxic substances such as mite, pollen, bacteria, mold, and virus, and then inactivates the suspended toxic substances such as mite, pollen, bacteria, mold, and virus. By adhesion fixing to the filter inactivating agents corresponding to the suspended toxic substances, efficient adsorption removal and inactivation are achieved to provide an air conditioner capable of preventing re-scattering of substances still having toxicity.

### Example 12

### Coating Filter with Treating Solution and Drying

Filters made from a polyester non-woven cloth were immersed into an ethanol solution of polyvinyl phenol. After drawing out the filters from the treating solution, they were each dried at room temperature, 100° C., 150° C., and 200° C., respectively. About 4 hours was necessary to dry the filter at room temperature until no liquid adhered to the hand when the surface of the filter was touched. Similar dry state was achieved in 15 minutes by drying at 100° C. Although similar dry state was achieved in 10 minutes by drying at 150° C., discoloration was partly observed. On drying at 200° C., discoloration and shrinking deformation of the filter were observed in 10 minutes. Similar results were obtained on polypropylene honeycomb filters.

The above treated filters were each spray-coated with an aqueous solution having dissolved therein catechin and an organic nitrogen based antifungal agent, to thereby obtain antibacterial/antifungal/antiallergenic/antivirus filters.

### Example 13

### Evaluation of Antibacterial, Antifungal, Antivirus, and Antiallergenic Performance of Filter

The effect of the filter produced in Example 12 on Escherichia coli and Staphylococcus aureus was studied. Suspension containing the bacteria at a level of 10⁵ bacteria/ml were brought into contact with the filter, to obtain zero viable counts after 24 hours. Similar tests were carried out on a non-treated filter, but no decrease in viable counts was observed.

The effect of the filter produced in Example 12 on mold was studied. The antibacterial/antifungal/antiallergenic/antivirus filter was mounted on a test culture media coated with a suspension of Penicillium spores, with which culture for 7 days was performed. After culture, an area with no mold (inhibition circle) was observed in the periphery of the filter and on the filter. Similar tests were carried out on a non-treated filter to observe propagation of mold over the entire surface of the culture media and the filter.

The effect of the filter produced in Example 12 on viruses was studied. The filter was coated with a test solution containing 10⁷ viruses/ml of influenza virus, and was stored in an air-tight state for 6 hours to prevent drying from occurring. Then, the virus solution was recovered from the filter. The infectability of the viruses to cells was measured to find a decrease in infectability by two or more orders of magnitude. In a non-treated filter, slight drop in infectability attributed to natural decrease was observed.

The antiallergenic performance of the filter produced in Example 12 was studied. Dust filth containing mite allergen collected from vacuum cleaner dust was mounted on the filter, and was stored for 24 hours. Then, the allergenicity was evaluated by using a mite allergen detector kit (product name: DaniScan) manufactured by ASAHI FOOD & HEALTHCARE, LTD. to find decrease in allergenicity. High allergenicity was observed on both non-treated filter and dust filth.

### Example 14

### Coating Filter with Treating Solution and Pressure Loss Measurement

An ethanol solution of polyvinyl phenol was sprayed onto polypropylene fibers, and was dried at 100° C. for 15 minutes to manufacture an air cleaning filter. Air was flown to the air cleaning filters at various rates to measure pressure loss and dust collecting efficiency. The results were the same as those obtained in Example 4; by adhering and fixing polyvinyl phenol to the filter, pressure loss as well as dust collecting efficiency slightly increased as compared with the case of non-treated filter.

### Example 15

### Filter Part Coated with Treating Solution and Pressure Loss Measurement

A dust collector filter having dense fiber morphology (low porosity), which is used for increasing dust collecting efficiency, was adhered to another dust collector filter consisting of less densely packed fibers but having excellent strength (high porosity) to obtain a filter (having low density on the back plane). Polyvinylphenol was adhesion fixed to the resulting filter by a method similar to Example 14. Dust collecting efficiency was measured at an air flow rate of 0.5 m/s for air cleaning filters to which the materials were adhered in various amounts and in various directions. Results similar to those obtained in Example 5 were obtained, and the dust collecting efficiency increased with increasing total amount of coverage. In this case, filters having the treating solution adhesion fixed to the plane of dust collector material having the larger porosity showed superior dust collecting efficiency as compared with the filter on which the solution was adhesion fixed to the plane of smaller porosity.

### Example 16

An air cleaner device equipped with an air cleaning filter having a constitution similar to that of Example 6 was manufactured.

### Example 17

A ventilator device equipped with an air cleaning filter having a constitution similar to that of Example 7 was manufactured.

### Example 18

A mask with an air cleaning filter having a constitution similar to that of Example 8 was manufactured.

### Example 19

A heater device or a mattress drier equipped with an air cleaning filter having a constitution similar to that of Example 10 was manufactured.

### Example 20

An air conditioner equipped with an air cleaning filter having a constitution similar to that of Example 11 was manufactured.

### INDUSTRIAL APPLICABILITY

The present invention has industrial applicability in the point that it provides; an air cleaner which efficiently sucks pollens, dead mites, and the like that are in the vicinity of the floor plane, and which exhibits antiallergenic effect for a long term; a functional filter which suppresses toxicity of the collected particulate matter substances, its simple method of production, and its application; and an air cleaning filter which suppresses toxicity of the collected particulate matter substances and its application.

1. An air cleaner comprising a main body with an inlet port and an outlet port formed thereon and provided with air blower means therein, an antiallergenic filter having an aromatic hydroxyl compound installed in the air flow passage of the air blower means inside the main body, wherein the inlet port formed in the main body is provided at the lower part of the front panel, such that the suction air flow may be formed along the floor plane.

2. An air cleaner as claimed in claim 1, wherein the aromatic hydroxyl compound is constituted by poly-4-vinylphenol.

3. An air cleaner as claimed in claim 1, wherein the outlet ports are provided to the both side panels of the main body.

4. An air cleaner as claimed in claim 1, wherein a dust sensor is provided to the lower part of the main body, and the air cleaner is so constituted that the main body is automatically operated when dust is detected by the dust sensor.

5. An air cleaner as claimed in claim 1, wherein an assistant inlet port is provided to the side panel of the main body.

6. An air cleaner as claimed in claim 5, wherein a shield part is provided so as to be protruded out from the side panel of the main body, on the front part of the assistant inlet port provided to the side panel of the main body, in such a manner that the assistant inlet port may not be directly visualized from the front side.

7. An air cleaner as claimed in claim 1, wherein a deodorizing filter is provided inside the main body and a gas sensor is provided to the upper part of the main body, and the air cleaner is so constituted that the main body is automatically operated when a gas is detected by the gas sensor.

8. A treating solution characterized in that it is prepared by dissolving and/or dispersing a water-soluble material and a water-insoluble material in a mixed solvent of water and a cellosolve and/or a carbitol.

9. A treating solution as claimed in claim 8, characterized in that the water-soluble material and the water-insoluble material are a mixture of two or more materials selected from a material having antibacterial properties, a material having antifungal properties, a material having antivirus properties, a material having antiallergenic properties, a material used as a colorant, and a material having hygroscopic properties.

10. A treating solution as claimed in claim 8, characterized in that the water-soluble material is a catechin.

11. A treating solution as claimed in claim 8, characterized in that the water-insoluble material is a high molecular antiallergenic agent having a high molecular phenolic hydroxyl group.

12. A treating solution as claimed in claim 8, characterized in that the ratio (volume ratio) of a cellosolve and/or a carbitol contained in the mixed solvent of water and a cellosolve and/or a carbitol is in a range from 20% to 99%.

13. A method for manufacturing a functional filter, characterized in that the treating solution as claimed in claim 8 is adhered to a filter base material, and dried thereafter.

14. A method for manufacturing a functional filter as claimed in claim 13, characterized in that the treating solution, being prepared by dissolving and/or dispersing a water-soluble material and a water-insoluble material in a mixed solvent of water and a cellosolve and/or a carbitol, is applied to the high-porosity part of the filter, and dried thereafter.

15. A method for manufacturing a functional filter, characterized in that a fiber raw material is immersed in the treating solution as claimed in claim 8, and the fiber obtained after drying is finished into a filter-like shape.

16. A method for manufacturing a functional filter as claimed in claim 13, characterized in that the drying temperature is 150° C. or lower.

17. A functional filter characterized in that it is manufactured by the method as claimed in claim 13.

18. A humidifying filter characterized in that it is made by coating a filter formed from a water-absorbing filter base material with the treating solution as claimed in claim 8.

19. A device characterized in that a functional filter as claimed in claim 17 and/or a humidifying filter, being made by coating a filter formed from a water-absorbing filter base material with the treating solution prepared by dissolving and/or dispersing a water-soluble material and a water-insoluble material in a mixed solvent of water and a cellosolve and/or a carbitol, is/are disposed between an air inlet port and an outlet port.

20. A device as claimed in claim 19, characterized in that a dust collector filter is provided to the back stage of the filter.

21. A device as claimed in claim 19, characterized in that it is one selected from an air cleaner device, a ventilator device, a humidifier device, a heater device, a dehumidifier device, a mattress drier, an air conditioner, and a heat exchanger device.

22. A water treatment device characterized in that a functional filter as claimed in claim 17 and/or a humidifying filter, being made by coating a filter formed from a water-absorbing filter base material with the treating solution prepared by dissolving and/or dispersing a water-soluble material and a water-insoluble material in a mixed solvent of water and a cellosolve and/or a carbitol, is/are disposed between a water inlet port and a water discharge port.

23. A device as claimed in claim 19, characterized in that the treating solution, being prepared by dissolving and/or dispersing a water-soluble material and a water-insoluble material in a mixed solvent of water and a cellosolve and/or a carbitol, is applied to the surface of the outer frame of the main body.

24. A mask characterized in that it comprises a functional filter as claimed in claim 17.

25. A functional filter as claimed in claim 17, characterized in that it is colored using a treating solution, being prepared by dissolving and/or dispersing a water-soluble material and a water-insoluble material in a mixed solvent of water and a cellosolve and/or a carbitol, containing a material used as a colorant.

26. A device as claimed in claim 23, characterized in that it is colored using a treating solution, being prepared by dissolving and/or dispersing a water-soluble material and a water-insoluble material in a mixed solvent of water and a cellosolve and/or a carbitol, containing a material used as a colorant.

27. An air cleaning filter characterized in that it contains adhered thereon two or more materials selected from a material having antiallergenic properties, a material having antibacterial properties, a material having antivirus properties, and a material having antifungal properties.

28. An air cleaning filter as claimed in claim 27, characterized in that the material having antiallergenic properties is an antiallergenic agent having a high molecular phenolic hydroxyl group.

29. An air cleaning filter as claimed in claim 27, characterized in that a catechin is incorporated as a material having antivirus properties.

30. An air cleaning filter as claimed in claim 27, characterized in that an enzyme is incorporated as a material having antibacterial properties.

31. An air cleaning filter as claimed in claim 27, characterized in that it is colored using a material known as a colorant.

32. An air cleaning filter as claimed in claim 27, characterized in that the material is adhered to the air cleaning filter at coverage of 0.1 to 10 g/m².

33. An air cleaning filter characterized in that the material as claimed in claim 27 is applied to the high-porosity part of the filter.

34. A device characterized in that an air cleaning filter as claimed in claim 27 is disposed between an air inlet port and an outlet port.

35. A device as claimed in claim 34, characterized in that a dust collector filter is provided to the back stage of the air cleaning filter.

36. A device as claimed in claim 35, characterized in that it is one selected from an air cleaner device, a ventilator device, a humidifier device, a heater device, a dehumidifier device, a mattress drier, and an air conditioner.

37. A mask characterized in that it comprises an air cleaning filter as claimed in claim 27.
